(19) United States
(12) Patent Application Publication
(10) Pub. No.: US 2014/0077701 A1
(43) Pub. Date: Mar. 20, 2014

(54) ION GENERATION APPARATUS AND ELECTRIC EQUIPMENT USING THE SAME

(71) Applicant: Hiromu Nishida, Osaka-shi (JP)

(72) Inventor: Hiromu Nishida, Osaka-shi (JP)

(73) Assignee: SHARP KABUSHIKI KAISHA, Osaka-shi, Osaka (JP)

(21) Appl. No.: 14/116,234

(22) PCT Filed: Apr. 18, 2012
(86) PCT No.: PCT/JP2012/060415

§ 371 Date: Nov. 7, 2013

(30) Foreign Application Priority Data
May 18, 2011 (JP) 2011-111349

(51) Int. Cl. H01J 27/02

(52) U.S. Cl. CPC H01J 27/022
USPC 315/111.81

(57) ABSTRACT

In this ion generation apparatus, an induction electrode is formed on a surface of a first printed substrate, a hole is opened on the inside of the induction electrode, a needle electrode is mounted on a second printed substrate, and a tip end portion of the needle electrode is inserted in the hole. Therefore, even if the ion generation apparatus is placed in a high-humidity environment with dust accumulating on the first and the second printed substrates, the ion generation apparatus can prevent a current from leaking between the needle electrode and the induction electrode.

### TECHNICAL FIELD

The present invention relates to an ion generation apparatus and electric equipment using the same, and particularly to an ion generation apparatus generating ions including an induction electrode and a needle electrode, and electric equipment using the same.

### BACKGROUND ART

Conventionally, an ion generation apparatus includes a substrate, an induction electrode, and a needle electrode. The induction electrode is annularly formed and mounted on a surface of the substrate. The needle electrode has a base end portion provided in the substrate, and a tip end portion arranged at a central portion of the induction electrode. When a high voltage is applied between the needle electrode and the induction electrode, corona discharge occurs at the tip end portion of the needle electrode, generating ions. The generated ions are delivered into a room by an air blower, and surround and decompose molds and viruses floating in the air (see, for example, Japanese Patent Laying-Open No. 2010-044917 (PTD 1)).

### CITATION LIST

### Patent Document

PTD 1: Japanese Patent Laying-Open No. 2010-044917

### SUMMARY OF INVENTION

### Technical Problem

However, in the conventional ion generation apparatus, since the needle electrode and the induction electrode are mounted on a surface of one substrate, when the ion generation apparatus is placed in a high-humidity environment with dust accumulating on the surface of the substrate, a current may leak between the needle electrode and the induction electrode via the moistened dust, causing a reduction in the amount of generated ions.

Therefore, a main object of the present invention is to provide an ion generation apparatus capable of generating ions stably even in a high-humidity environment, and electric equipment using the same.

### Solution to Problem

An ion generation apparatus in accordance with the present invention is an ion generation apparatus generating ions including an induction electrode and a needle electrode, including a first substrate having a hole opened therein, and a second substrate provided to face one surface of the first substrate. The induction electrode is provided around the hole in the first substrate. The needle electrode has a base end portion provided in the second substrate, and a tip end portion inserted in the hole. Therefore, since the induction electrode and the needle electrode are separately provided to the first and the second substrates, respectively, even if the ion generation apparatus is placed in a high-humidity environment with dust accumulating on the first and the second substrates, the ion generation apparatus can prevent a current from leaking between the needle electrode and the induction electrode, and can generate ions stably.

Preferably, the ion generation apparatus further includes a lid member provided to cover another surface of the first substrate and having a cylindrical boss at a position corresponding to the hole, wherein the boss is inserted in the hole, and the needle electrode is inserted in the boss. In this case, since the first and the second substrates are covered with the lid member, accumulation of dust on the first and the second substrates can be prevented. Furthermore, even if dust enters through the boss, the dust is less likely to accumulate on the first substrate, although the dust may accumulate on the second substrate. In addition, since the boss is provided, a spatial distance between the needle electrode and the induction electrode can be increased. Therefore, the ion generation apparatus can prevent a current from leaking between the needle electrode and the induction electrode more effectively.

Preferably, the tip end portion of the needle electrode penetrates through the boss and protrudes from the lid member. In this case, even if dust accumulates in the vicinity of an opening of the boss, the ion generation apparatus can prevent the dust from burying the tip end portion of the needle electrode and disturbing discharge of the needle electrode. Furthermore, even if dust sticks to the tip end portion of the needle electrode, the dust can be blown off the needle electrode by applying a high voltage to the needle electrode while blowing the air to the tip end portion of the needle electrode.

Preferably, the induction electrode is annularly formed around the hole in the first substrate.

Preferably, the first substrate is a printed substrate, and the induction electrode is formed of a wiring layer of the printed substrate. In this case, the induction electrode can be formed at a low cost, and the cost of the ion generation apparatus can be reduced.

Further, electric equipment in accordance with the present invention includes the ion generation apparatus described above, and an air blowing portion delivering ions generated by the ion generation apparatus.

### Advantageous Effects of Invention

In the ion generation apparatus in accordance with the present invention, since the induction electrode and the needle electrode are separately provided to the first and the second substrates, respectively, even if the ion generation apparatus is placed in a high-humidity environment with dust accumulating on the first and the second substrates, the ion generation apparatus can prevent a current from leaking between the needle electrode and the induction electrode, and can generate ions stably.

### BRIEF DESCRIPTION OF DRAWINGS

FIG. 1 is a cross sectional view showing a configuration of an ion generation apparatus in accordance with one embodiment of the present invention.

FIG. 2 is a perspective view of the ion generation apparatus shown in FIG. 1.

FIG. 3 is a perspective view of the ion generation apparatus shown in FIG. 2 with a lid member being removed therefrom.

FIG. 4 is a circuit diagram showing a configuration of the ion generation apparatus shown in FIG. 1.

FIG. 5 is a cross sectional view showing a configuration of an air cleaner using the ion generation apparatus shown in FIG. 1.

FIG. 6 is a cross sectional view showing a comparative example of the embodiment.

### DESCRIPTION OF EMBODIMENTS

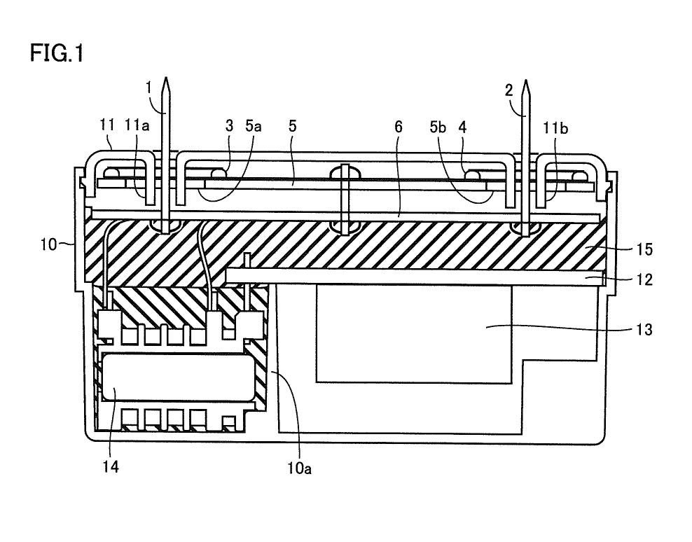

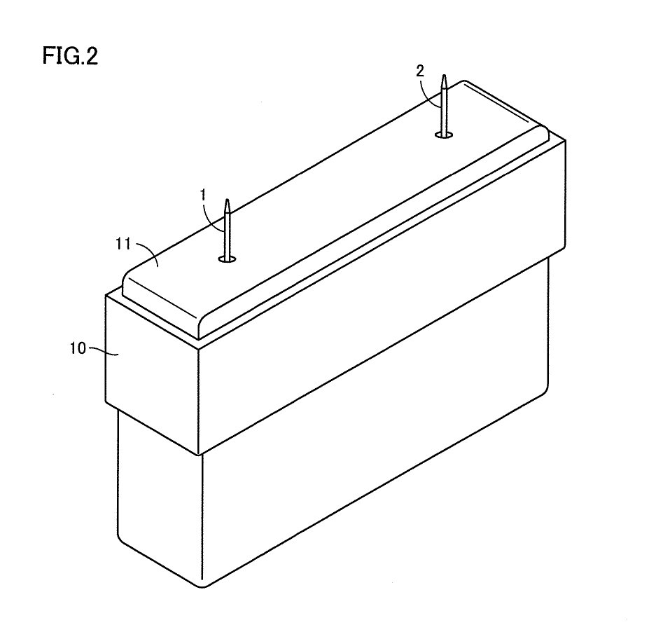

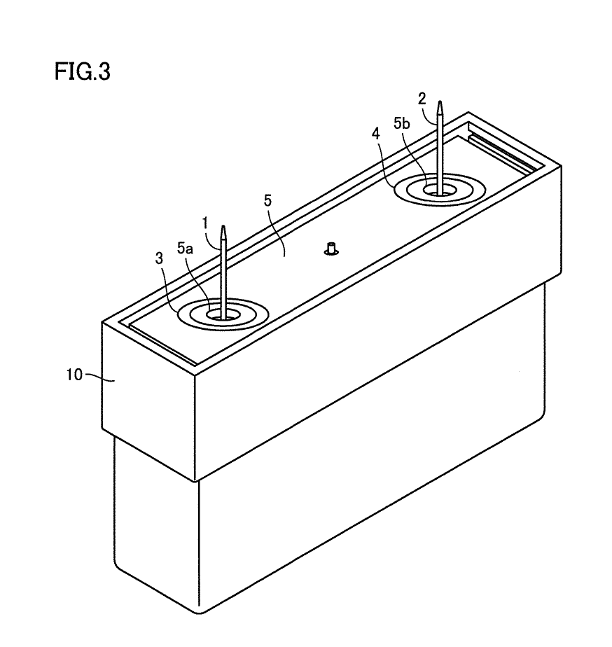

As shown in FIGS. 1 to 3, an ion generation apparatus in accordance with one embodiment of the present invention includes a needle electrode 1 for generating positive ions, a needle electrode 2 for generating negative ions, an annular induction electrode 3 for forming an electric field between itself and needle electrode 1, an annular induction electrode 4 for forming an electric field between itself and needle electrode 2, and two rectangular printed substrates 5, 6.

Printed substrates 5, 6 are arranged parallel to each other in a vertical direction in FIG. 1, with a predetermined interval therebetween. Induction electrode 3 is formed on a surface of printed substrate 5 at one end portion in a longitudinal direction, using a wiring layer of printed substrate 5. A hole 5a penetrating through printed substrate 5 is opened on the inside of induction electrode 3. Further, induction electrode 4 is formed on the surface of printed substrate 5 at the other end portion in the longitudinal direction, using a wiring layer of printed substrate 5. A hole 5b penetrating through printed substrate 5 is opened on the inside of induction electrode 4.

Each of needle electrodes 1, 2 is provided perpendicular to printed substrates 5, 6. Specifically, needle electrode 1 has a base end portion inserted in a hole in printed substrate 6, and a tip end portion penetrating through the center of hole 5a in printed substrate 5. Further, needle electrode 2 has a base end portion inserted in a hole in printed substrate 6, and a tip end portion penetrating through the center of hole 5b in printed substrate 5. The base end portion of each of needle electrodes 1, 2 is fixed to printed substrate 5 by soldering. The tip end portion of each of needle electrodes 1, 2 is sharply pointed.

Further, the ion generation apparatus includes a rectangular parallelepiped casing 10 having a rectangular opening slightly larger than printed substrates 5, 6, a lid member 11 closing the opening in casing 10, a circuit substrate 12, a circuit component 13, and a transformer 14.

Casing 10 is formed of an insulating resin. A lower portion of casing 10 is formed to be slightly smaller than its upper portion, and a level difference is formed at a boundary between the upper portion and the lower portion of casing 10 in inner walls of casing 10. Further, the lower portion of casing 10 is divided by a partition plate 10a into two in the longitudinal direction. Transformer 14 is accommodated at the bottom on one side of partition plate 10a. Circuit substrate 12 is provided on partition plate 10a and the level difference to close a space on the other side of partition plate 10a. Circuit component 13 is mounted on a lower surface of circuit substrate 12, and is accommodated in the space on the other side of partition plate 10a.

Printed substrates 5, 6 are accommodated in the upper portion of casing 10. Circuit substrate 12, transformer 14, and printed substrates 5, 6 are electrically connected by wiring. A resin 15 for insulation is charged in a high-voltage portion within casing 10. Resin 15 is charged up to a lower surface of printed substrate 6. It is noted that, in the present embodiment, resin 15 is not charged in the space on the other side of partition plate 10a, because it is not necessary to insulate circuit component 13 connected to a primary side of transformer 14 with resin 15.

Lid member 11 is formed of an insulating resin. Grooves are formed in upper end portions of the inner walls of casing 10, and locking portions to be inserted in the grooves in casing 10 protrude at both ends of lid member 11 in the longitudinal direction. In addition, a cylindrical boss 11a is formed in a lower surface of lid member 11 at a position corresponding to hole 5a and needle electrode 1. Further, a cylindrical boss 11b is formed in the lower surface of lid member 11 at a position corresponding to hole 5b and needle electrode 2.

Bosses 11a, 11b have inner diameters larger than outer diameters of needle electrodes 1, 2, respectively. In addition, bosses 11a, 11b have outer diameters smaller than inner diameters of holes 5a, 5b in printed substrate 5, respectively. Bosses 11a, 11b penetrate through holes 5a, 5b in printed substrate 5, respectively. A slight gap is formed between tip end surfaces (lower end surfaces) of bosses 11a, 11b and a surface of printed substrate 6. Needle electrodes 1, 2 penetrate through bosses 11a, 11b, respectively, and the tip end portions of needle electrodes 1, 2 protrude above lid member 11 by about 10 mm.

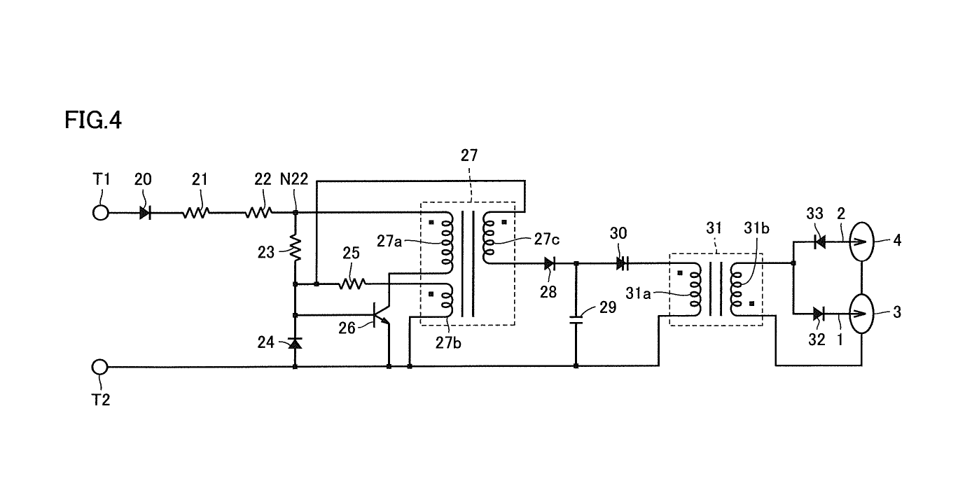

FIG. 4 is a circuit diagram showing a configuration of the ion generation apparatus. In FIG. 4, the ion generation apparatus includes, in addition to needle electrodes 1, 2 and induction electrodes 3, 4, a power supply terminal T1, a ground terminal T2, diodes 20, 24, 28, 32, and 33, resistance elements 21 to 23 and 25, an NPN bipolar transistor 26, boost transformers 27 and 31, a capacitor 29, and a diode thyristor 30. A portion of the circuit in FIG. 4 other than needle electrodes 1, 2 and induction electrodes 3, 4 is constituted by circuit substrate 12, circuit component 13, transformer 14, and the like in FIG. 1.

A positive terminal and a negative terminal of a direct current (DC) power supply are connected to power supply terminal T1 and ground terminal T2, respectively. A DC power supply voltage (for example, +12V or +15V) is applied to power supply terminal T1, and ground terminal T2 is grounded. Diode 20 and resistance elements 21 to 23 are connected in series between power supply terminal T1 and a base of transistor 26. An emitter of transistor 26 is connected to ground terminal T2. Diode 24 is connected between ground terminal T2 and the base of transistor 26

Diode 20 is an element for protecting the DC power supply by blocking a current when the positive terminal and the negative terminal of the DC power supply are reversely connected to terminals T1 and T2. Resistance elements 21 and 22 are elements for limiting a boost operation. Resistance element 23 is a starting resistance element. Diode 24 operates as a reverse voltage protection element for transistor 26.

Boost transformer 27 includes a primary winding 27a, a base winding 27b, and a secondary winding 27c. Primary winding 27a has one terminal connected to a node N22 between resistance elements 22 and 23, and the other terminal connected to a collector of transistor 26. Base winding 27b has one terminal connected to the base of transistor 26 via resistance element 25, and the other terminal connected to ground terminal T2. Secondary winding 27c has one terminal connected to the base of transistor 26, and the other terminal connected to ground terminal T2 via diode 28 and capacitor 29.

Boost transformer 31 includes a primary winding 31a and a secondary winding 31b. Diode thyristor 30 is connected between a cathode of diode 28 and one terminal of primary winding 31a. The other terminal of primary winding 31a is connected to ground terminal T2. Secondary winding 31b has one terminal connected to induction electrodes 3 and 4, and the other terminal connected to an anode of diode 32 and a cathode of diode 33. A cathode of diode 32 is connected to the base end portion of needle electrode 1, and an anode of diode 33 is connected to the base end portion of needle electrode 2.

Resistance element 25 is an element for limiting a base current. Diode thyristor 30 is an element that becomes conductive when a voltage across terminals reaches a breakover voltage, and becomes nonconductive when a current is reduced to a minimum holding current or less.

Next, an operation of the ion generation apparatus will be described. Capacitor 29 is charged by an operation of an RCC-type switching power supply. Specifically, when the DC power supply voltage is applied across power supply terminal T1 and ground terminal T2, a current flows from power supply terminal T1 to the base of transistor 26 via diode 20 and resistance elements 21 to 23, and transistor 26 becomes conductive. Thereby, a current flows to primary winding 27a of boost transformer 27, and a voltage is generated across terminals of base winding 27b.

The winding direction of base winding 27b is set to further increase a base voltage of transistor 26 when transistor 26 becomes conductive. Therefore, the voltage generated across the terminals of base winding 27b reduces a conductive resistance value of transistor 26 in a positive feedback state. The winding direction of secondary winding 27c is set such that diode 28 blocks energization on this occasion, and no current flows to secondary winding 27c.

As the current flowing to primary winding 27a and transistor 26 continues to increase in this manner, a collector voltage of transistor 26 is increased beyond a saturation region. Thereby, a voltage across the terminals of primary winding 27a is reduced, the voltage across the terminals of base winding 27b is also reduced, and thus the collector voltage of transistor 26 is further increased. Accordingly, transistor 26 operates in the positive feedback state, and transistor 26 immediately becomes nonconductive. On this occasion, secondary winding 27c generates a voltage in a conducting direction of diode 28. Thereby, capacitor 29 is charged.

When a voltage across terminals of capacitor 29 is increased to reach the breakover voltage of diode thyristor 30, diode thyristor 30 operates like a Zener diode and further passes a current. When the current flowing to diode thyristor 30 reaches a breakover current, diode thyristor 30 is substantially short-circuited, and an electric charge charged in capacitor 29 is discharged via diode thyristor 30 and primary winding 31a of boost transformer 31, generating an impulse voltage in primary winding 31a.

When the impulse voltage is generated in primary winding 31a, positive and negative high-voltage pulses are alternately generated in an attenuating manner in secondary winding 31b. The positive high-voltage pulses are applied to needle electrode 1 via diode 32, and the negative high-voltage pulses are applied to needle electrode 2 via diode 33. Thereby, corona discharge occurs at tip ends of needle electrodes 1, 2, and positive ions and negative ions are generated, respectively.

On the other hand, when a current flows to secondary winding 27c of boost transformer 27, the voltage across the terminals of primary winding 27a is increased and transistor 26 becomes conductive again, and the operation described above is repeated. The speed of repeating the operation is increased with an increase in the current flowing to the base of transistor 26. Therefore, by adjusting a resistance value of resistance element 21, the current flowing to the base of transistor 26 can be adjusted, and thus the number of discharges of needle electrodes 1, 2 can be adjusted.

It is noted that positive ions are cluster ions formed in such a manner that a plurality of water molecules surround a hydrogen ion (H⁺), and expressed as H⁺(H₂O)ₘ (m is any natural number). In addition, negative ions are cluster ions formed in such a manner that a plurality of water molecules surround an oxygen ion (O₂⁻), and expressed as O₂⁻(H₂O). (n is any natural number). When positive ions and negative ions are emitted into a room, both ions surround molds and viruses floating in the air, and cause a chemical reaction with each other on the surfaces thereof. As a result of action of hydroxyl radicals (•OH) representing active species produced at that time, floating molds and the like are eliminated.

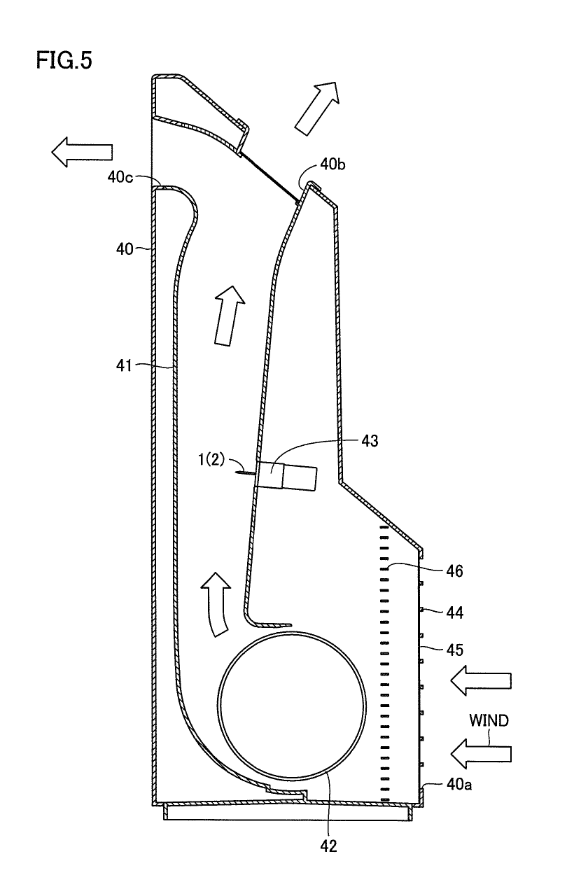

FIG. 5 is a cross sectional view showing a configuration of an air cleaner using the ion generation apparatus shown in FIGS. 1 to 4. In FIG. 5, in the air cleaner, an inlet 40a is provided in a back surface of a lower portion of a main body 40, and outlets 40b, 40c are provided in a back surface and a front surface, respectively, of an upper portion of main body 40. Further, a duct 41 is provided inside main body 40, an opening at a lower end of duct 41 is provided to face inlet 40a, and an upper end of duct 41 is connected to outlets 40b, 40c.

A cross flow fan 42 is provided in the opening at the lower end of duct 41, and an ion generation apparatus 43 is provided at a central portion of duct 41. Ion generation apparatus 43 is the one shown in FIGS. 1 to 4. A main body of ion generation apparatus 43 is fixed to an outer wall surface of duct 41, and needle electrodes 1, 2 thereof penetrate through a wall of duct 41 and protrude into duct 41. Two needle electrodes 1, 2 are aligned in a direction perpendicular to a direction in which the air inside duct 41 flows.

Further, a lattice grill 44 made of a resin is provided at inlet 40a, and a thin mesh filter 45 is attached to the inside of grill 44. A fan guard 46 is provided behind filter 45 to prevent a foreign substance or a user's finger from entering cross flow fan 42.

When cross flow fan 42 is rotationally driven, the air in a room is taken into duct 41 via inlet 40a. Molds and the like contained in the intake air are eliminated by ions generated by ion generation apparatus 43. The cleaned air passing through ion generation apparatus 43 is emitted into the room via outlets 40b, 40c.

In the present embodiment, induction electrodes 3, 4 are mounted on printed substrate 5 and needle electrodes 1, 2 are mounted on printed substrate 6. Therefore, even if the ion generation apparatus is placed in a high-humidity environment with dust accumulating on printed substrates 5, 6, the ion generation apparatus can prevent a current from leaking between needle electrode 1, 2 and induction electrode 3, 4, and can generate ions stably.

Further, since printed substrates 5, 6 are covered with lid member 11, accumulation of dust on printed substrates 5, 6 can be prevented. Furthermore, even if dust enters through bosses 11a, 11b, the dust is less likely to accumulate on printed substrate 5, although the dust may accumulate on printed substrate 6. In addition, since bosses 11a, 11b of lid member 11 are inserted in holes 5a, 5b in printed substrate 5, respectively, and needle electrodes 1, 2 are inserted in bosses 11a, 11b, respectively, a spatial distance between needle electrode 1, 2 and induction electrode 3, 4 can be increased. Therefore, the ion generation apparatus can prevent a current from leaking between needle electrode 1, 2 and induction electrode 3, 4 more effectively.

Further, since the tip end portions of needle electrodes 1, 2 penetrate through bosses 11a, 11b and protrude above lid member 11, even if dust accumulates in the vicinity of openings of bosses 11a, 11b, the ion generation apparatus can prevent the dust from burying the tip end portions of needle electrodes 1, 2 and disturbing discharge of needle electrodes 1, 2. Furthermore, even if dust sticks to the tip end portions of needle electrodes 1, 2, the dust can be blown off needle electrodes 1, 2 by applying a high voltage to needle electrodes 1, 2 while blowing the air to the tip end portions of needle electrodes 1, 2.

Further, since induction electrodes 3, 4 are formed using the wiring layers of printed substrate 5, induction electrodes 3, 4 can be formed at a low cost, and the cost of the ion generation apparatus can be reduced.

It is noted that, although the tip ends of needle electrodes 1, 2 protrude above lid member 11 in the present embodiment, the tip ends of needle electrodes 1, 2 may be lower than an upper surface of lid member 11.

Further, although induction electrodes 3, 4 are formed using the wiring layers of printed substrate 5 in the present embodiment, each of induction electrodes 3, 4 may be formed of a metal plate. In addition, each of induction electrodes 3, 4 may not be annular.

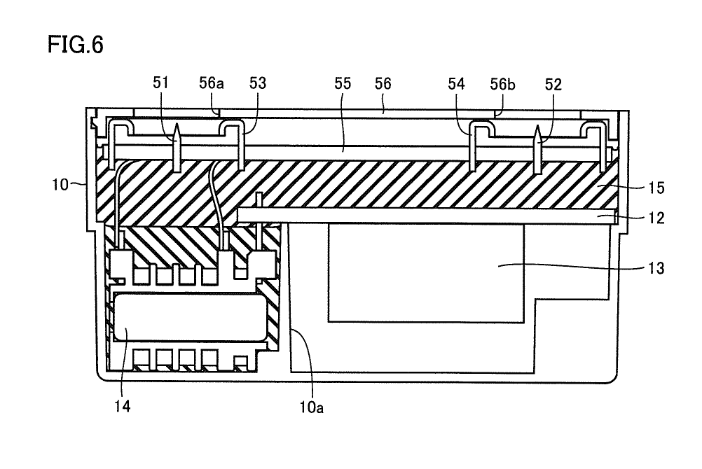

FIG. 6 is a cross sectional view showing a configuration of an ion generation apparatus in accordance with a comparative example of the embodiment described above. In FIG. 6, the ion generation apparatus includes a needle electrode 51 for generating positive ions, a needle electrode 52 for generating negative ions, an annular induction electrode 53 for forming an electric field between itself and needle electrode 51, an annular induction electrode 54 for forming an electric field between itself and needle electrode 52, a rectangular printed substrate 55, and a flat plate-like lid member 56.

Induction electrode 53 is annularly formed of a metal plate, and is mounted at one end portion of a surface of printed substrate 55. Needle electrode 51 has a base end portion inserted in a hole at one end portion of printed substrate 55, and a tip end portion arranged at a central portion of induction electrode 53. Induction electrode 54 is annularly formed of a metal plate, and is mounted at the other end portion of the surface of printed substrate 55. Needle electrode 52 has a base end portion inserted in a hole at the other end portion of printed substrate 55, and a tip end portion arranged at a central portion of induction electrode 54.

Printed substrate 55 is accommodated in an upper portion of casing 10. An opening in casing 10 is closed by lid member 56. Holes 56a, 56b are opened in lid member 56 at positions facing needle electrodes 51, 52, respectively. Tip ends of needle electrodes 91, 92 are accommodated within casing 10. Ions generated at needle electrodes 51, 52 are supplied to the outside via holes 56a, 56b in lid member 56.

In the ion generation apparatus, since needle electrodes 51, 52 and induction electrodes 53, 54 are mounted on one printed substrate 55, when the ion generation apparatus is placed in a high-humidity environment with dust accumulating on the surface of printed substrate 55, a current may leak between needle electrode 51, 52 and induction electrode 53, 54 via the moistened dust, causing a reduction in the amount of generated ions.

Further, since the tip end portions of needle electrodes 51, 52 do not protrude out of casing 10, when the ion generation apparatus is placed inside duct 41, ions generated at the tip end portions of needle electrodes 51, 52 cannot be efficiently emitted to the outside on the wind inside duct 41.

It should be understood that the embodiment disclosed herein is illustrative and non-restrictive in every respect. The scope of the present invention is defined by the scope of the claims, rather than the description above, and is intended to include any modifications within the scope and meaning equivalent to the scope of the claims.

### REFERENCE SIGNS LIST

1, 2, 51, 52: needle electrode; 3, 4, 53, 54: induction electrode; 5, 6, 55: printed substrate; 5a, 5b, 56a, 56b: hole; 10: casing; 11, 56: lid member; 11a, 11b: boss; 12: circuit substrate; 13: circuit component; 14: transformer; 15: resin; T1: power supply terminal; T2: ground terminal; 20, 24, 28, 32, 33: diode; 21 to 23, 25: resistance element; 26: NPN bipolar transistor; 27, 31: boost transformer; 27a, 31a: primary winding; 27b: base winding; 27c, 31b: secondary winding; 29: capacitor; 30: diode thyristor; 40: main body; 40a: inlet; 40b, 40c: outlet; 41: duct; 42: cross flow fan; 43: ion generation apparatus; 44: grill; 45: filter; 46: fan guard.

1. An ion generation apparatus generating ions including an induction electrode and a needle electrode, comprising:
a first substrate having a hole opened therein; and
a second substrate provided to face one surface of said first substrate,
said induction electrode being provided around said hole in said first substrate,
said needle electrode having a base end portion provided in said second substrate, and a tip end portion inserted in said hole.

2. The ion generation apparatus according to claim 1, further comprising a lid member provided to cover another surface of said first substrate and having a cylindrical boss at a position corresponding to said hole, wherein
said boss is inserted in said hole, and said needle electrode is inserted in said boss.

3. The ion generation apparatus according to claim 2, wherein the tip end portion of said needle electrode penetrates through said boss and protrudes from said lid member.

4. The ion generation apparatus according to claim 1, wherein said induction electrode is annularly formed around said hole in said first substrate.

5. The ion generation apparatus according to claim 1, wherein
said first substrate is a printed substrate, and
said induction electrode is formed of a wiring layer of said printed substrate.

6. Electric equipment, comprising:
the ion generation apparatus according to claim 1; and
an air blowing portion delivering ions generated by said ion generation apparatus.
